(19) United States
(12) Patent Application Publication
(10) Pub. No.: US 2014/0331061 A1
(43) Pub. Date: Nov. 6, 2014

(54) DRIVE LEVEL ENCRYPTION KEY MANAGEMENT IN A DISTRIBUTED STORAGE SYSTEM

(71) Applicant: SOLIDFIRE, INC, Boulder, CO (US)

(72) Inventors: David D. WRIGHT, Boulder, CO (US); John STILES, Erie, CO (US); Jim WILSON, Louisville, CO (US)

(21) Appl. No.: 13/875,902

(22) Filed: May 2, 2013

(51) Int. Cl. G06F 21/60

(52) U.S. Cl. CPC G06F 21/602
USPC 713/189

(57) ABSTRACT

Disclosed are systems, computer-readable mediums, and methods for receiving an input/output operation regarding data associated with a distributed storage system that includes a plurality of storage devices. A key identifier associated with the I/O operation is determined. The key identifier identifies a key that has been divided into a number of key pieces. Two or more storage devices of the plurality of storage devices that contain one or more of the key pieces are determined and at least a threshold number of key pieces are requested from the two or more storage devices. The minimum number of key pieces needed to reconstruct the key is the threshold number. The key is reconstructed from the requested key pieces. A cryptographic function is performed on data associated with the I/O operation using the reconstructed key and the I/O operation is completed based upon the performed cryptographic function.

### BACKGROUND

The following description is provided to assist the understanding of the reader. None of the information provided is admitted to be prior art.

Drive level encryption encrypts all data that is stored on a drive. FIG. 1 depicts a drive level encryption system. A storage device 102 contains a storage area 106, such as a platter-based hard drive. A client 108 can read and write unencrypted data to the storage device 102. The store device 102, however, stores the data in an encrypted format. The client 108 can request that unencrypted data be stored on the storage device 102. Prior to the data being stored, an encryptor/decryptor unit 104 encrypts the data using a key. The encrypted data is then written to the storage area 106. When the client 108 reads the previously written data, the encrypted data is retrieved from the storage area 106 and decrypted by the encryptor/decryptor unit 104 using the key. The decrypted data is then returned to the client 108. Thus, from the client's perspective, the data encryption of their data is transparent. In FIG. 1, the storage device 102 is a self contained device. Accordingly, the encryptor/decryptor 104 can maintain a list of keys that can be used to encrypt/decrypt data.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims. Like reference numbers and designations in the various drawings indicate like elements.

FIG. 1 depicts a drive level encryption system.

FIG. 2 depicts drive level encryption in a distributed storage system in accordance with an illustrative implementation.

FIG. 3 depicts drive level encryption with a key manager in a distributed storage system in accordance with an illustrative implementation.

FIG. 4 shows a flow diagram of reconstructing a key for use in an I/O operation in accordance with an illustrative implementation.

FIG. 5 shows a flow diagram of storing key pieces in a distributed storage system in accordance with an illustrative implementation.

### DETAILED DESCRIPTION

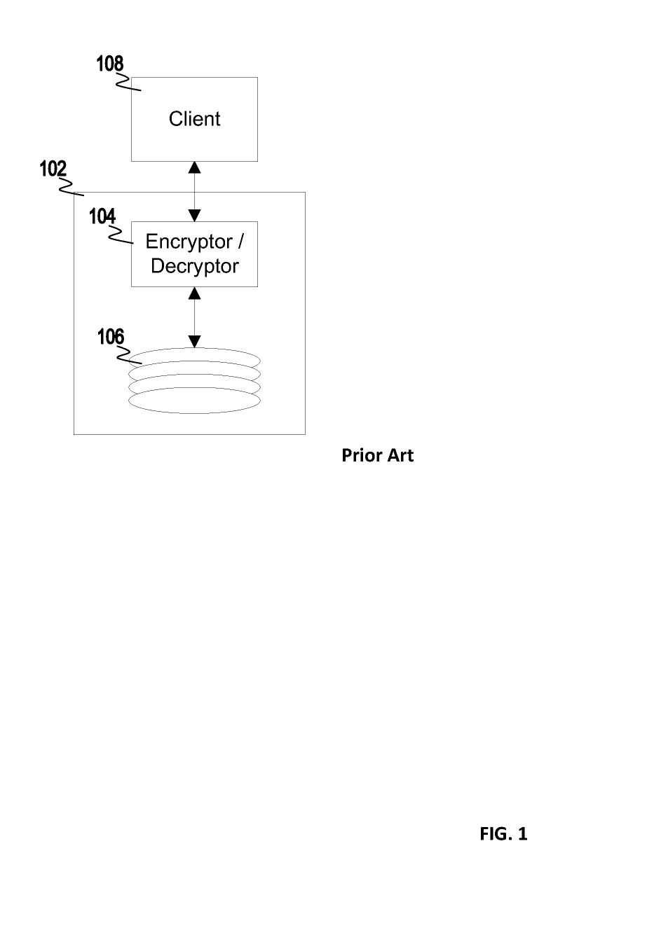

In general, the subject matter described in this specification is related to key management in a distributed storage system. Unlike a single storage device system, a distributed storage system includes multiple storage devices, each of which can store a portion of a client's data. Similar though to a single storage device of FIG. 1, the client's data is encrypted prior to being stored on any storage device. Where the encryption key is stored, however, can utilize the multiple storage devices in the distributed storage system.

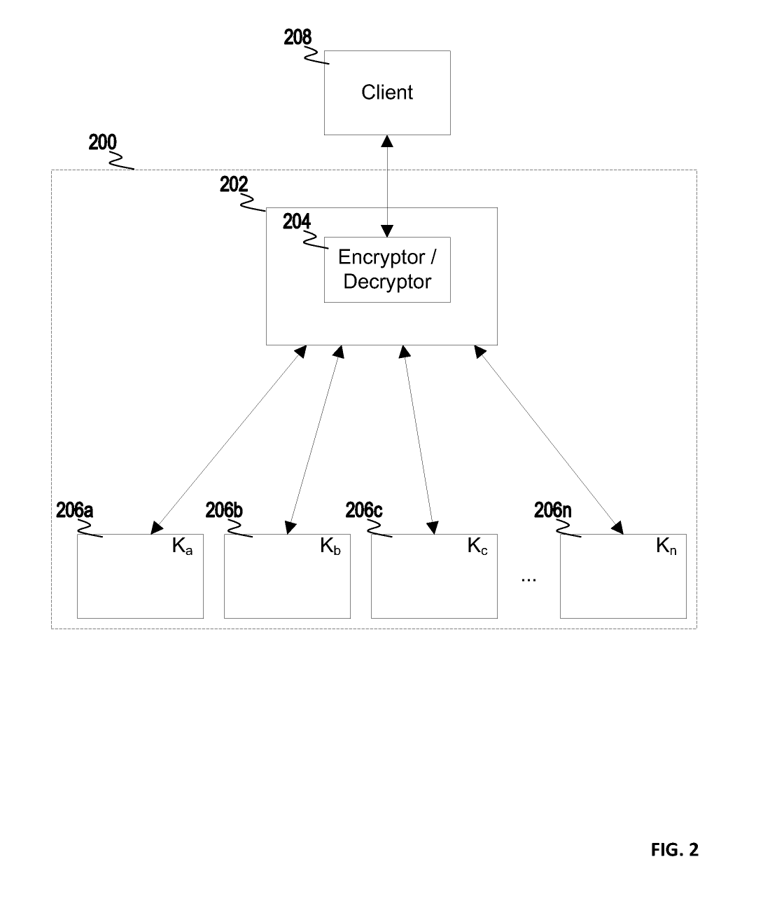

FIG. 2 depicts drive level encryption in a distributed storage system 200 in accordance with an illustrative implementation. A client 208 can store data in the distributed storage system 200. The data can be stored on one or more storage devices 206a-206n and accessed through an interface device 202. In some implementations, the interface device 202 can also be a storage device. In one implementation, the data is stored evenly across all available storage devices 206a-206n. An encryptor/decryptor unit 204 encrypts and decrypts the client's data as needed. The encryptor/decryptor unit 204 can use a key to encrypt and decrypt the data of the client 208. Accordingly, both the encryption/decryption of the client's data and the data being stored across multiple storage devices is transparent to the client 208.

As shown in FIG. 2, the encryptor/decryptor unit 204 can be located in the interface device 202. In another implementation, each storage device 206a-206n can have its own encryptor/decryptor unit that is used to encrypt/decrypt data that is stored/read from the storage device. The key used by the storage device can be retrieved a variety of ways. For example, the interface device 202 can provide each storage device 206a-206n with the appropriate key to use. The interface device 202 can provide the key when data is read/written to the storage device. In another implementation, the storage device can request the key from the interface device 202 or another device within the distributed storage system 200. As another example, the storage device can retrieve a key from various other storage devices 206a-206n as described in greater detail below. Once a storage device has a key, the key can be cached for later I/O accesses. When the storage devices 206a-206n include an encryptor/decryptor, each storage device 206a-206n can have its own key. In another implementation, a single key can be used across two or more storage devices.

### Key Storage

The key used by the encryptor/decryptor unit 204 can be stored on one or more of the storage devices 206a-206n. For example, the entire key can be stored on one or more storage devices 206a-206n or in the interface device 202. The encryptor/decryptor unit 204 can include a mapping of which storage devices 206a-206n contain the key associated with the client.

In other implementations, Sharmir's Secret Sharing algorithm can be used to spread a key across multiple storage devices 206a-206n. In another implementation, parts of a key can be spread across storage devices 206a-206n and/or other devices within the distributed storage system 200. These implementations involve two parameters: a number of parts and a threshold. The number of parts is the number of pieces the key will be divided into. The threshold is the minimum number of parts required to be able to reconstruct the original key. In one implementation, the number of parts and the threshold are set to the same number. In other implementations, the threshold is less than the number of parts.

As a specific example, a key can be divided into four different parts with a threshold of four. Each of the storage devices 206a, 206b, 206c, and 206n can store one of the parts, e.g., Kₐ, K_{b}, K_{c}, and K_{d}. When the key is needed, the encryptor/decryptor unit 204 can request each part from each of the storage devices 206a, 206b, 206c, and 206n. Once the key parts are received, the key can be reconstructed and the data can be encrypted/decrypted using the reconstructed key. In another implementation, the interface device 202 can also store one or more pieces of the key. The encryptor/decryptor unit 204 can request these pieces of the key from the interface device 202. In one implementation, the encryptor/decryptor unit 204 has a data structure that includes which storage devices have a piece of a particular key. Using this data structure, the encryptor/decryptor unit 204 can determine which storage devices to request key data from. In another implementation, the interface device 202 or another storage device can store the data structure.

As another example of dividing a key, the threshold can be less than the total number of key pieces. For example, a key could be split into three key pieces, but only two key pieces are needed to reconstruct the key. These key pieces could be stored on any one or more of the storage devices 206a-206n. For example, storage devices 206a, 206b, and 206c could be used to store the three key pieces. When a key is needed, the encryptor/decryptor unit 204 can request the key pieces from any two of the storage devices 206a, 206b, and 206c, or from all three. This allows the encryptor/decryptor unit 204 to reconstruct the key from key pieces received from the first two storage devices that respond. In addition, if one of the storage devices is offline, the encryptor/decryptor unit 204 is still able to generate the key and encrypt/decrypt the client's data as needed.

Not all storage devices have to include a piece of a particular key. For example, if a key was split into a number of key pieces that was less than the total number of storage devices used in the distributed storage system 200, the pieces of the key could be stored on a subset of the storage devices.

A single key can be split multiple times. For example, a key can initially be split into three key parts and the key parts stored in the distributed storage system 200. The key can also be split a second time into five key parts. For example, the key can be split if changes occur to the distributed storage system 200. These key pieces can also be stored in the distributed storage system 200. The original three key pieces can be deleted from the distributed storage system 200 or can be kept. If the original three key pieces are kept, the distributed storage system 200 can use either set of key pieces to reconstruct the key. As an example, if the key was slit into five key pieces and these five key pieces were stored in the distributed storage system 200 such that the storage devices that included the original three key pieces did not completely overlap with the storage devices that store the five key pieces, the key can be generated from either the three key pieces or the five key pieces. If a number of storage devices fail such that the key cannot be regenerated from the five key pieces, the distributed storage system 200 can attempt to reconstruct the keys using the original three parts.

In another implementation, key pieces are stored redundantly through the distributed storage system 200. For example, a key can be broken up into five key pieces. Each key piece can be stored on two or more distinct storage devices. This redundancy allows the key to be reconstructed even if a number of storage devices are taken offline. The interface device 202 or the encryptor/decryptor unit 204 can include a data structure which indicates what storage devices contain what key pieces. This data structure can then be used to determine which storage devices to request key pieces from.

### Distributed Key Usage

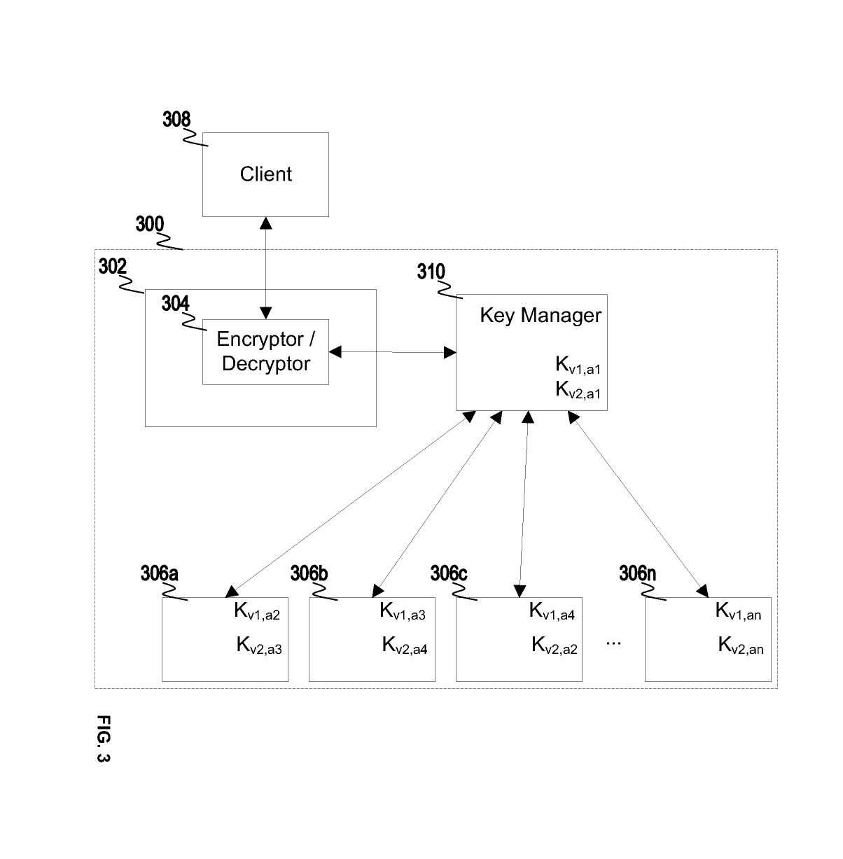

In another implementation, a key manager can be used to manage the generation and/or the storage of keys. FIG. 3 depicts drive level encryption with a key manager 310 in a distributed storage system 300 in accordance with an illustrative implementation. In this system, the encryptor/decryptor unit 304 requests a key from the key manager 310. The key manager 310 determines where key pieces are stored and how many key pieces are needed to reconstruct the key. The key pieces can be requested from the storage devices 306a-306n that have at least one key piece by the key manager 310. After receiving the required key pieces, the key manager 310 can reconstruct the key. Once the key is reconstructed it is sent back to the encryptor/decryptor unit 304. The interface device 302 can request encrypted data from the storage devices 306a-306n, and the encryptor/decryptor unit 304 can decrypt the data using the received key prior to sending the data to the client 308. In implementations where more than one key is used, the possible keys can be stored in a data structure, such as an array, hash, etc. In one implementation, a hash is used to store keys. An identifier, such as a volume identifier, a client identifier, etc., can be used to determine which key to use. If a key is not present in the data structure, the key can be generated. Once generated the key can be cached for future use. In another implementation, the key manager 310 can be a remote key manager that is external to the distributed storage system 300.

The described distributed storage systems can be used simultaneously by multiple clients. In one implementation, all of the data in the distributed storage system is encrypted/decrypted using the same key. In another implementation, each volume has its own key. Each client can have one or more volumes that are used to store the client's data. In this implementation, each volume key can be divided into key pieces and the key pieces stored with the distributed storage system as described above. As shown in FIG. 3, the storage devices 306a-306n can include one or more key pieces of multiple volume keys. When data from a particular volume is to be read or written, the key manager 310 can request the key pieces corresponding to the volume from the storage devices 306a-306n. In another implementation, each client has its own key that is used to encrypt/decrypt the client's data regardless of the volume on which the client's data is stored.

In some implementations, a particular device of the distributed storage system 300 can be required to be accessible to reconstruct the key. For example, the key manager 310 can be required to be accessible to reconstruct the key associated with a volume of the client 308. This can be accomplished, by storing a number of key pieces on the key manager 310 such that at least one of those key pieces is needed to reconstruct the key. For example, a key can be broken into eight key pieces and the threshold can be set to five. Four different key pieces can be stored on the key manager 310, and the other four pieces can be stored on one or more of the storage devices 306a-306n. In this example, five key pieces are needed to reconstruct the key. At least one key piece stored on the key manager 310, therefore, is needed to reconstruct the key. Accordingly, the key manager 310 can request four of the key pieces from the corresponding storage devices 306a-306n, but must receive at least one key piece from itself. In this example, the key manager 310 must be available to encrypt/decrypt the client's data. In another implementation, a single device can have a number of key pieces such that the key can be reconstructed solely from the key pieces on that device. For example, using the example above, the interface device 302 could store five of the eight key pieces. The key could then be reconstructed based solely on the key pieces from the interface device 302.

When a volume in the storage system has its own key, the entire volume can be made inaccessible by deleting some key parts associated with the volume. This feature is useful in deleting the volume. Volume deletion can be accomplished such that unencrypted data from the deleted volume is inaccessible without requiring all of the encrypted data to be deleted from the storage devices. This can be accomplished by deleting enough key pieces such that the key associated with the encrypted data can no longer be reconstructed. For example, a key associated with a volume of a client can be split into ten different key pieces, any six of which will allow for the reconstruction of the key. If the client wishes to delete the volume, five or more key pieces can be removed from the storage system. As the remaining five or less key pieces are not enough to reconstruct the key, the storage system is no longer able to decrypt the encrypted data. The client, therefore, is ensured that once a volume is deleted their data is not accessible by anyone, even if the encrypted data remains in the distributed storage system. The distributed storage system can reclaim space from the deleted volume as needed or when the load of the distributed storage system is below a predetermined level.

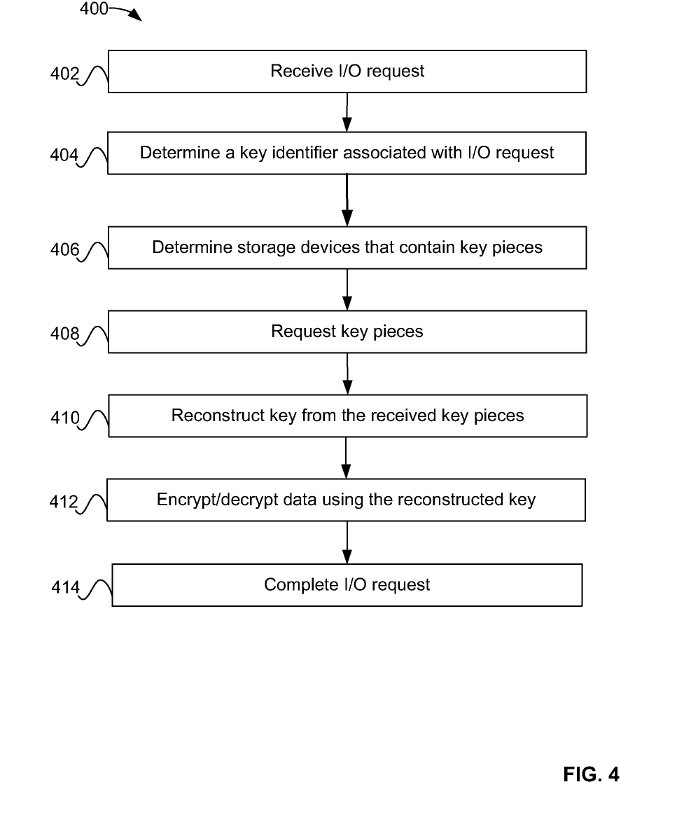

FIG. 4 is a flow diagram of a process 400 for reconstructing a key for use in an input/output (I/O) operation in accordance with an illustrative implementation. The process 400 can be implemented on a computing device. In one implementation, the process 400 is encoded on a computer-readable medium that contains instructions that, when executed by a computing device, cause the computing device to perform operations of the process 400. In another implementation, the process 400 can be implemented as a hardware component.

The process 400 includes receiving an I/O request (402). For example, an interface unit can receive a read request, a write request, etc. The request can include a volume identifier. A key identifier associated with the I/O request is determined (404). For example, an encryptor/decryptor unit can determine the key identifier based upon the volume identifier, the client associated with the volume, etc. In another implementation, a distributed storage system uses a single key and thus, there is no need for a key identifier. As the key has previously been broken up and stored on one or more storage devices, the storage devices that store at least one key piece of the key is determined (406). In one implementation, this can be done using the key identifier. For example, the key identifier can be used to retrieve a data structure that identifies all of the storage devices that include at least one key piece. In some implementations, the data structure can also indicate how many key pieces each storage device contains, as well as the threshold number of key pieces needed to reconstruct the key. Key pieces can be requested from the storage devices (408). Once a threshold number or more of key pieces have been received, the key can be reconstructed based upon the received key pieces (410). For example, Shamir's shared secret algorithm can be used to reconstruct the key. Using the reconstructed key, a cryptographic function, e.g., encrypting, decrypting, etc., can be executed on the data as needed based upon the I/O request (412). For example, a client could be writing data into the distributed storage system. This data can be encrypted using the key. Once encrypted, the I/O request can be completed by writing the encrypted data into one or more storage devices (414). The client could also be requesting data from the distributed storage system. In this case, encrypted data corresponding to the requested data could be retrieved from one or more storage devices and then be decrypted using the reconstructed key. The I/O request can then be completed by sending the decrypted data back to the client (414). In another implementation, keys can be cached. Prior to constructing a key, the cache can be accessed to determine if the appropriate key is already known. If the needed key is cached, the I/O request can be processed using the key from the cache, rather than reconstructing the key.

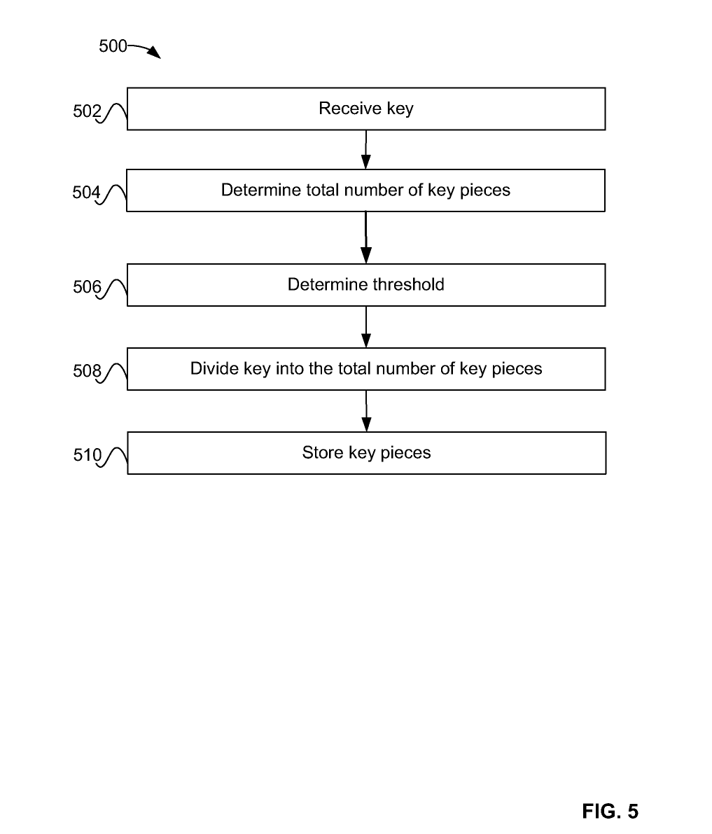

FIG. 5 is a flow diagram of process 500 for storing key pieces in a distributed storage system in accordance with an illustrative implementation. The process 500 can be implemented on a computing device. In one implementation, the process 500 is encoded on a computer-readable medium that contains instructions that, when executed by a computing device, cause the computing device to perform operations of the process 500. In another implementation, the process 500 can be implemented as a hardware component.

The process 500 includes receiving a key (502). In one implementation, the key can be generated by a component of the distributed storage system, e.g., an interface unit, a key manager, an encryptor/decryptor unit, a storage device, etc. A total number of key pieces to break the key into is determined (504). The total number of key pieces can be a predetermined number, such as, but not limited to, 5, 8, 10, 25, etc. In another implementation, the total number of key pieces is determined based upon the characteristics of the distributed storage system. In one implementation, the total number of key pieces is based upon the total number of storage devices. For example, the total number of key pieces can be equal to two thirds, one half, one quarter, etc., of the total number of storage devices. In another implementation, the number of key pieces can equal the number of storage devices. A threshold is also determined (506). The threshold is the minimum number of key pieces needed to successfully reconstruct the key. Accordingly, the threshold is less than or equal to the total number of key pieces. Once the total number of key pieces and threshold are determined the key is divided into key pieces (508). For example, the key can be broken into key pieces using Shamir's Secret Sharing algorithm. Once the key pieces have been generated, they are then stored in the distributed storage system (510). In the implementation, where the number of key pieces is equal to the number of storage devices, each storage device can store one key piece. In other implementations, a number of key pieces can be stored on a single storage device. As described in greater detail above, a number of key pieces can be stored in one component of the distributed storage system such that the one component is required to reconstruct the key. To ensure the key can be reconstructed later, where the key pieces are stored can be recorded in a data structure.

One or more flow diagrams have been used herein. The use of flow diagrams is not meant to be limiting with respect to the order of operations performed. The herein-described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The foregoing description of illustrative implementations has been presented for purposes of illustration and of description. It is not intended to be exhaustive or limiting with respect to the precise form disclosed, and modifications and variations are possible in light of the above teachings or may be acquired from practice of the disclosed implementations. It is intended that the scope of the invention be defined by the claims appended hereto and their equivalents.

What is claimed is:

1. A method comprising:
receiving an input/output (I/O) operation regarding data associated with a distributed storage system, wherein the distributed storage system comprises a plurality of storage devices;
determining, using a processor, a key identifier associated with the I/O operation, wherein the key identifier identifies a key that has been divided into a number of key pieces;
determining two or more storage devices of the plurality of storage devices that contain one or more of the key pieces;
requesting at least a threshold number of key pieces from the two or more storage devices, wherein a minimum number of key pieces needed to reconstruct the key is the threshold number;
reconstructing the key from the requested key pieces;
performing an cryptographic function on data associated with the I/O operation using the reconstructed key; and
completing the I/O operation based upon the performed cryptographic function.

2. The method of claim 1, wherein the I/O operation is a read request, and wherein the method further comprises:
reading encrypted data from one or more storage devices of the distributed storage system, wherein the performed cryptographic function is decrypting the encrypted data using the key, and wherein the completed I/O operation is returning the decrypted data.

3. The method of claim 1, wherein the I/O operation is a write request that comprises data to be written, wherein the performed cryptographic function is encrypting the data to be written using the key, and wherein the method further comprises:
writing the encrypted data to one or more storage devices of the distributed storage system, wherein the completed I/O operation a result of the I/O operation.

4. The method of claim 1, wherein a number of key pieces are stored on one storage device such that at least one key piece must be retrieved from the one storage device to reconstruct the key.

5. The method of claim 4, wherein the number of key pieces stored on the one storage device is equal to or greater than the total number of key pieces minus the threshold number plus one.

6. The method of claim 1, wherein the I/O operation includes a volume identifier, and wherein the key identifier is determined based upon the volume identifier.

7. The method of claim 1, wherein one or more storage devices do not store any of the key pieces.

8. The method of claim 1, wherein the number of key pieces is less than or equal to the number of storage devices in the distributed storage system.

9. The method of claim 1, wherein the I/O operation is a volume delete request, and wherein the method further comprises:
deleting a number of key pieces from the distributed storage system such that less than the threshold number of the key pieces remain in the distributed storage system.

10. A system comprising:
one or more electronic processors configured to:
receive an input/output (I/O) operation regarding data associated with a distributed storage system, wherein the distributed storage system comprises a plurality of storage devices;
determine a key identifier associated with the I/O operation, wherein the key identifier identifies a key that has been divided into a number of key pieces;
determine two or more storage devices of the plurality of storage devices that contain one or more of the key pieces;
request at least a threshold number of key pieces from the two or more storage devices, wherein a minimum number of key pieces needed to reconstruct the key is the threshold number;
reconstruct the key from the requested key pieces;
perform an cryptographic function on data associated with the I/O operation using the reconstructed key; and
complete the I/O operation based upon the performed cryptographic function.

11. The system of claim 10, wherein the I/O operation is a read request, and wherein the one or more processors are further configured to:
read encrypted data from one or more storage devices of the distributed storage system, wherein the performed cryptographic function is decrypting the encrypted data using the key, and wherein the completed I/O operation is returning the decrypted data.

12. The system of claim 10, wherein the I/O operation is a write request that comprises data to be written, wherein the performed cryptographic function is encrypting the data to be written using the key, and wherein the one or more processors are further configured to:
write the encrypted data to one or more storage devices of the distributed storage system, wherein the completed I/O operation a result of the I/O operation.

13. The system of claim 10, wherein a number of key pieces are stored on one storage device such that at least one key piece must be retrieved from the one storage device to reconstruct the key.

14. The system of claim 10, wherein the I/O operation includes a volume identifier, and wherein the key identifier is determined based upon the volume identifier.

15. The system of claim 1, wherein the I/O operation is a volume delete request, and wherein the one or more processors are further configured to: delete a number of key pieces from the distributed storage system such that less than the threshold number of the key pieces remain in the distributed storage system.

16. A non-transitory computer-readable medium having instructions stored thereon, the instructions comprising:
instructions to receive an input/output (I/O) operation regarding data associated with a distributed storage system, wherein the distributed storage system comprises a plurality of storage devices;
instructions to determine a key identifier associated with the I/O operation, wherein the key identifier identifies a key that has been divided into a number of key pieces;
instructions to determine two or more storage devices of the plurality of storage devices that contain one or more of the key pieces;
instructions to request at least a threshold number of key pieces from the two or more storage devices, wherein a minimum number of key pieces needed to reconstruct the key is the threshold number;
instructions to reconstruct the key from the requested key pieces;
instructions to perform an cryptographic function on data associated with the I/O operation using the reconstructed key; and
instructions to complete the I/O operation based upon the performed cryptographic function.

17. The non-transitory computer-readable medium of claim 16, wherein the I/O operation is a read request, and wherein the instructions further comprise:
instructions to read encrypted data from one or more storage devices of the distributed storage system, wherein the performed cryptographic function is decrypting the encrypted data using the key, and wherein the completed I/O operation is returning the decrypted data.

18. The non-transitory computer-readable medium of claim 16, wherein the I/O operation is a write request that comprises data to be written, wherein the performed cryptographic function is encrypting the data to be written using the key, and wherein the instructions further comprise:
instructions to write the encrypted data to one or more storage devices of the distributed storage system, wherein the completed I/O operation a result of the I/O operation.

19. The non-transitory computer-readable medium of claim 16, wherein a number of key pieces are stored on one storage device such that at least one key piece must be retrieved from the one storage device to reconstruct the key.

20. The non-transitory computer-readable medium of claim 16, wherein the I/O operation includes a volume identifier, and wherein the key identifier is determined based upon the volume identifier.
